(19) United States
(12) Patent Application Publication
(10) Pub. No.: US 2010/0197839 A1
(43) Pub. Date: Aug. 5, 2010

(54) POLYMERIC COMPOSITIONS, HAVING AN IMPROVED WHITNESS INDEX, PROCESS OF PRODUCING THE SAME, AND ARTICLES MADE THEREFROM

(76) Inventor: Timothy W. Gambrel, Lake Jackson, TX (US)

Correspondence Address: Ray Ashburg;The Dow Chemical Company, 2030 Dow Center, Midland, MI, 48674, US

(21) Appl. No.: 12/670,768

(22) PCT Filed: Jul. 2, 2008
(86) PCT No.: PCT/US08/69007

§ 371 Date: Jan. 26, 2010

Related U.S. Application Data
(60) Provisional application No. 60/952,961, filed on Jul. 31, 2007.

(51) Int. Cl. C08K 5/13; C08K 5/5317

(52) U.S. Cl. 524/132; 524/323

(57) ABSTRACT

The instant invention is a polymeric composition, process of producing the same, and articles made therefrom. The polymeric composition according to instant invention comprises: (1) a polyolefin, wherein said polyolefin is the polymerization reaction product of at least one or more α-olefins in the presence of a solvent via a solution polymerization reaction; and (2) a phenolic antioxidant. The polymeric composition contains less than 0.02 parts of copper per one million parts of the composition, and the polymeric composition has a whiteness index according to ASTM-D 6290 of equal or greater than [(−0.73 X)+(Wᵢ)] where X is the number of days of accelerated aging, and Wi is the initial whiteness index at 0 days of accelerated aging. The process for producing the polymeric composition according to instant invention includes the following steps: (1) selecting a copper free polymerization system; (2) polymerizing at least one or more α-olefins in the presence of a solvent via a solution polymerization reaction in the copper free polymerization system; (3) thereby producing a polyolefin polymer; (4) melt blending a phenolic antioxidant into the polyolefin polymer; and (5) thereby producing the polymeric composition, wherein the polymeric composition contains less than 0.02 parts of copper per one million parts of the composition, and the polymeric composition has a whiteness index according to ASTM-D 6290 of equal or greater than [(−0.73 X)+(Wᵢ)] where X is the number of days of accelerated aging, and Wi is the initial whiteness index at 0 days of accelerated aging. The articles according to instant invention comprise the above-described polymeric composition.

### CROSS-REFERENCE TO RELATED APPLICATIONS

This application is a non-provisional application claiming priority from the U.S. Provisional Patent Application No. 60/952,961, filed on Jul. 31, 2007, entitled “POLYMERIC COMPOSITIONS HAVING AN IMPROVED WHITNESS INDEX, PROCESS OF PRODUCING THE SAME, AND ARTICLES MADE THEREFROM,” the teachings of which are incorporated by reference herein, as if reproduced in full hereinbelow.

### FIELD OF INVENTION

The instant invention relates to polymeric compositions having an improved whiteness index, process of producing the same, and articles made therefrom.

### BACKGROUND OF THE INVENTION

In order to prolong the life of polymers, various stabilizers such as antioxidants and ultraviolet light absorbers are added to polymers. Exemplary antioxidants include, but are not limited to, sterically hindered phenol antioxidants and phosphite-based antioxidants. Typically, hindered phenols act as radical scavengers, also known as radical traps or chain breaking antioxidant, and they are characterized by a hydroxyl group flanked by two tertiary butyl substituents. In the polymer, the hydroxyl hydrogen atom is readily abstracted by macroalkyl radicals, thus terminating their propagation. The tertiary butyl substituents, in the ortho position to the hydroxyl group, provide stearic hindrance, preventing the newly formed phenoxyl radical from removing a hydrogen atom from the polymer chain. The phenoxyl radical can then be rearranged to scavenge another radical or can react with another phenoxyl radical or oxygen. Phenolic antioxidants are generally used with synergistic hydroperoxide decomposers such as organic phosphites. In some instances, however, polyolefins cannot be effectively stabilized even with the addition of such stabilizers. This usually occurs when the polyolefin is in contact with a metal, particularly copper, or contains within its composition certain metallic impurities, for example, catalyst residues. The end-result is that even though the stabilizers have been added, polyolefins decompose and lose their desirable physical properties sooner than expected.

In solution polyolefin polymerization, the polymerization typically takes place in the presence of a solvent. After the polymer is isolated, the solvent is recovered and then recycled back into the polymerization system via a solvent recovery unit including at least one heat exchanger and/or at least one vapor liquid separator drum. The solvent recovery unit is partially made of a nickel/copper alloy. The solvent typically comes into contact with the solvent recovery unit during the recovery stage. However, random periodic polymer discolorations have been observed that may be linked to use of copper containing solvent recovery units.

Despite the research efforts in developing stabilized polyolefins, there is still a need for stabilized polyolefins having improved discoloration properties. Furthermore, there is still a need for a method of producing stabilized polyolefins having improved discoloration properties.

### SUMMARY OF THE INVENTION

The instant invention is a polymeric composition having an improved whiteness index, process of producing the same, and articles made therefrom. The polymeric composition according to instant invention comprises: (1) a polyolefin, wherein the polyolefin is the polymerization reaction product of at least one or more α-olefins in the presence of a solvent via a solution polymerization reaction; and (2) a phenolic antioxidant. The polymeric composition contains less than 0.02 parts of copper per one million parts of the composition, and the polymeric composition further has a whiteness index according to ASTM-D 6290 of equal or greater than [(−0.73 X)+(Wᵢ)] where X is the number of days of accelerated aging, and Wᵢ is the initial whiteness index at 0 days of accelerated aging. The process for producing the polymeric composition according to instant invention includes the following steps: (1) selecting a copper free polymerization system; (2) polymerizing at least one or more α-olefins in the presence of a solvent via a solution polymerization reaction in the copper free polymerization system; (3) thereby producing a polyolefin polymer; (4) melt blending a phenolic antioxidant into the polyolefin polymer; and (5) thereby producing the polymeric composition, wherein the polymeric composition contains less than 0.02 parts of copper per one million parts of the composition, and the polymeric composition further has a whiteness index according to ASTM-D 6290 of equal or greater than [(−0.73 X)+(Wᵢ)] where X is the number of days of accelerated aging, and Wᵢ is the initial whiteness index at 0 days of accelerated aging. The articles according to instant invention comprise the above-described polymeric composition.

In one embodiment, the instant invention provides a polymeric composition having an improved whiteness index comprising: (1) a polyolefin, wherein said polyolefin is the polymerization reaction product of at least one or more α-olefins in the presence of a solvent via a solution polymerization reaction; and (2) a phenolic antioxidant, wherein the polymeric composition contains less than 0.02 parts of copper per one million parts of the composition, and the polymeric composition further has a whiteness index according to ASTM-D 6290 of equal or greater than [(−0.73 X)+(Wᵢ)] where X is the number of days of accelerated aging, and Wᵢ is the initial whiteness index at 0 days of accelerated aging.

In an alternative embodiment, the instant invention further provides a process for producing a polymeric composition comprising the following steps: (1) selecting a copper free polymerization system; (2) polymerizing at least one or more α-olefins in the presence of a solvent via a solution polymerization reaction in the copper free polymerization system; (3) thereby producing a polyolefin polymer; (4) melt blending a phenolic antioxidant into the polyolefin polymer; and (5) thereby producing the polymeric composition, wherein the polymeric composition contains less than 0.02 parts of copper per one million parts of the composition, and the polymeric composition further has a whiteness index according to ASTM-D 6290 of equal or greater than [(−0.73 X)+(Wᵢ)] where X is the number of days of accelerated aging, and Wᵢ is the initial whiteness index at 0 days of accelerated aging.

In another alternative embodiment, the instant invention provides an article comprising a polymeric composition, wherein the polymeric composition comprises: (1) a polyolefin, wherein said polyolefin is the polymerization reaction product of at least one or more α-olefins in the presence of a solvent via a solution polymerization reaction; and (2) a phenolic antioxidant, wherein the polymeric composition contains less than 0.02 parts of copper per one million parts of the composition, and the polymeric composition further has a whiteness index according to ASTM-D 6290 of equal or greater than [(−0.73 X)+(Wᵢ)] where X is the number of days of accelerated aging, and Wᵢ is the initial whiteness index at 0 days of accelerated aging.

In an alternative embodiment, the instant invention provides a polymeric composition, method of producing the same, and articles made therefrom, in accordance with any of the preceding embodiments, except that polymeric composition is free of copper.

In an alternative embodiment, the instant invention provides a polymeric composition, method of producing the same, and articles made therefrom, in accordance with any of the preceding embodiments, except that the phenolic antioxidant is selected from the group consisting of octadecyl 3-(3,5-di-tert-butyl-4-hydroxyphenyl)propionate; and 3,5-di-tert-butyl-4-hydroxy hydrocinnamate.

In an alternative embodiment, the instant invention provides a polymeric composition, method of producing the same, and articles made therefrom, in accordance with any of the preceding embodiments, except that the polymeric composition further comprises a phosphite-based antioxidant.

In an alternative embodiment, the instant invention provides a polymeric composition, method of producing the same, and articles made therefrom, in accordance with the preceding embodiment, except that the phosphite-base antioxidant is Tris(2,4-di-tert-butylphenyl)phosphite.

In an alternative embodiment, the instant invention provides a polymeric composition, and articles made therefrom, in accordance with any of the preceding embodiments, except that the polymerization reaction takes place in a copper free polymerization system.

In an alternative embodiment, the instant invention provides a polymeric composition, method of producing the same, and articles made therefrom, in accordance with any of the preceding embodiments, except that the polymer is produced in multiple reactors in series where the final reactor in the reaction system operates non-isothermally.

In an alternative embodiment, the instant invention provides a polymeric composition, method of producing the same, and articles made therefrom, in accordance with the preceding embodiment, except that the final reactor in the reaction system is a continuously stirred or plug flow variety.

In an alternative embodiment, the instant invention provides a polymeric composition, method of producing the same, and articles made therefrom, in accordance with any of the two preceding embodiments, except that there are no fresh reactants or catalyst being added in the final reactor.

In an alternative embodiment, the instant invention provides a polymeric composition, method of producing the same, and articles made therefrom, in accordance with any of the three preceding embodiments, except that the penultimate reactor operates isothermally and at higher monomer concentration than the standard isothermal reactor conditions.

### BRIEF DESCRIPTION OF THE DRAWINGS

For the purpose of illustrating the instant invention, there is shown in the drawings a form that is presently preferred; it being understood, however, that this invention is not limited to the precise arrangements and instrumentalities shown.

FIG. 1 is a graph illustrating the effects of increasing copper levels on whiteness index as a function of aging time.

### DETAILED DESCRIPTION OF THE INVENTION

The instant invention is a polymeric composition having an improved whiteness index, process of producing the same, and articles made therefrom.

The polymeric composition according to instant invention comprises: (1) a polyolefin, wherein the polyolefin is the polymerization reaction product of at least one or more α-olefins in the presence of a solvent via a solution polymerization reaction; and (2) a phenolic antioxidant.

The polyolefin may be any homopolymer and/or copolymer of one or more olefins. For example, the polyolefin may be a homopolymer of ethylene or a copolymer of ethylene with one or more α-olefins such as propylene, 1-butene, 1-pentene, 1-hexene, 1-heptene, 1-octene, 1-nonene, 1-decene, and 4-methyl-1-pentene. In the alternative, the polyolefin may be a homopolymer of propylene or a copolymer of propylene with one or more α-olefins such as ethylene, 1-butene, 1-pentene, 1-hexene, 1-heptene, 1-octene, 1-nonene, 1-decene, and 4-methyl-1-pentene.

Phenolic antioxidants may, for example, be any hindered phenolic compound. For example, such hindered phenolic compounds include, but are not limited to, 3,5-di-tert-butyl-4-hydroxy hydrocinnamate, and octadecyl 3-(3,5-di-tert-butyl-4-hydroxyphenyl)propionate commercially available under the tradenames Irganox® 1010 (CAS No. 6683-19-8), and Irganox® 1076 (CAS No. 2082-79-3), respectively, from Ciba Specialty Chemicals Company. The polymeric composition may comprise 200 to 800 parts by weight of the phenolic antioxidant per one million parts of the polymeric composition.

The polymeric composition may further include a phosphite-base antioxidant. Exemplary phosphite-based antioxidants include, but are not limited to, Tris(2,4-di-tert-butylphenyl)phosphite under the tradename Irgafos® 168 commercially available from Ciba Specialty Chemicals Company. The polymeric composition may comprise 800 to 1500 parts by weight of the phosphite-base antioxidant per one million parts of the polymeric composition.

The polymeric composition preferably contains less than 0.02 parts of copper per one million parts of the polymeric composition. In the alternative, the polymeric composition is copper free.

The polymeric composition may have any whiteness index. For example, the polymeric composition may have a whiteness index according to ASTM-D 6290 of equal or greater than [(−0.73 X)+(Wᵢ)] where X is the number of days of accelerated aging, and Wᵢ is the initial whiteness index at 0 days of accelerated aging. For example, the polymeric composition may have an initial whiteness index of equal or greater than 40, for example, 45.5.

The process for producing the polymeric composition according to instant invention includes the following steps: (1) selecting a copper free polymerization system; (2) polymerizing at least one or more α-olefins in the presence of a solvent via a solution polymerization reaction in the copper free polymerization system; (3) thereby producing a polyolefin polymer; (4) melt blending a phenolic antioxidant into the polyolefin polymer; and (5) thereby producing the polymeric composition, wherein the polymeric composition contains less than 0.02 parts of copper per one million parts of the composition, and the polymeric composition further has a whiteness index according to ASTM-D 6290 of equal or greater than [(−0.73 X)+(Wᵢ)] where X is the number of days of accelerated aging, and Wᵢ is the initial whiteness index at 0 days of accelerated aging.

The instant invention is further described in connection with the polymerization of ethylene homopolymers and/or ethylene/α-olefin copolymers; however, the instant invention is not so limited, and it may be employed in the polymerization any olefin polymer and/or any olefin copolymers; for example, the instant invention may be employed in the polymerization propylene homopolymers or propylene/α-olefin copolymers.

In solution polymerization of linear low-density polyethylene, that is, an ethylene/α-olefin copolymer having a linear molecular structure, the polymerization, according to instant invention requires copolymerizing ethylene and one or more chosen comonomers, for example, one or more α-olefins, using a catalyst in a copper free polymerization system. Such catalysts are generally known to those of ordinary skill in the art. Exemplary catalysts include, but are not limited to, Ziegler/Natta catalysts, metallocene catalysts, constrained geometry catalysts, and/r single-site catalysts. The polymerization occurs in a well-stirred reactor such as loop reactors or sphere reactors at temperature in the range of 150° C. to 575° C., preferably in the range of 175° C. to 205° C., and at pressures in the range of 435 psi to 725 psi. Ethylene, solvent, catalyst, and comonomers are fed continuously to the reactor. Exemplary solvents include, but are not limited to, isoparaffin, commercially under the tradename Isopar™ E from ExxonMobil Chemical Company, Houston, Tex. The mixture of polymer and solvent is removed from the reactor. The polymer is isolated, and further compounded. The solvent is recovered via a solvent recovery unit including at least one heat exchanger and at least one vapor liquid separator drum, and it is then recycled back into the polymerization system. One or more antioxidants may further be compounded into the polymer, and compounded polymer may then be pelletized. The compounded polymer may contain any amount of one or more antioxidant. For example, the compounded polymer may comprise 200 to 600 parts of one or more phenolic antioxidant per one million parts of the polymer. In addition, the compounded polymer may comprise 800 to 1200 parts of a phosphite-based antioxidant per one million parts of polymer. The compounded polymer may further comprise 200 to 1500 parts of calcium stearate per one million parts of polymer.

The polymerization system is copper free. For example, the polymerization system may be made fully or partially from a metal or a metal alloy free of any copper. Such metal alloys are well known to those skilled in the art; for example, the metal alloy may be alloy steels containing high percentages of chromium such as stainless steel. The solvent recovery unit including at least one heat exchanger and/or at least one vapor liquid separator drum of the copper free polymerization system is also preferably copper free. The solvent recovery unit including at least one heat exchanger and/or at least one vapor liquid separator drum is preferably made from a metal or a metal alloy free of copper. As mentioned above, such metals and metal alloys are well know to those skilled in the art; for example, the metal alloy may be alloy steels containing high percentages of chromium such as stainless steel.

The articles according to instant invention comprise the above-described polymeric composition. Different processes may be employed to form different articles. Such processes include, but are not limited, to injection molding, injection blow molding, rotational molding, blown film process, cast film process, thermoforming process, and/or, extrusion coating. Exemplary articles include, but are not limited to, bottles, caps, containers, films, fibers, foams, sheets, extruded coated articles, and/or packaging articles.

### EXAMPLES

It is understood that the present invention is operable in the absence of any component, which has not been specifically disclosed. The following examples are provided in order to further illustrate the invention and are not to be construed as limiting.

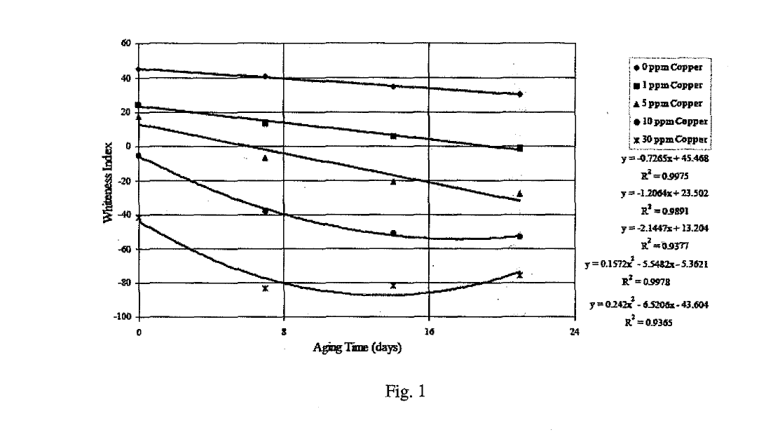

In order to show the detrimental effects of copper presence, polyethylene composition samples 1-5 containing different amounts of copper stearate were prepared. The polyethylene composition samples 1-5 included heterogeneously branched linear low-density copolymer of ethylene and octene having a density in the range of 0.92 g/cm³ according to ASTM-D 792 and a melt index in the range of 1.0 according to ASTM-D 1238, which is commercially available under the tradename DOWLEX™ 2045 from The Dow™ Chemical Company. The formulations for these heterogeneously branched linear low-density copolymer of ethylene and octene samples are shown in Table I. The samples were prepared according to the following procedure. 0.015 g of copper stearate having a MW of approximately 630.46 was dry mixed with 50 g of DOWLEX™ 2045 thereby forming a 30 ppm copper/polyethylene batch material. The batch material was then blended with the appropriate amount of base resin, that is, DOWLEX™ 2045, to form uniform polyethylene composition samples 1-5 via a Haake Polylab bowl mixer. The polyethylene composition samples 1-5 were then pressed into plaques via a Tetrahedron Model 0801 press using carbon steel metal plates, and aged in an oven at 70° C. for 21 days. The samples were tested for whiteness index according to ASTM D-6290 every 7 days, and the results are shown in FIG. 1.

### Test Methods

Test methods include the following:

The whiteness index was measured according to ASTM-D 6290.

The present invention may be embodied in other forms without departing from the spirit and the essential attributes thereof, and, accordingly, reference should be made to the appended claims, rather than to the foregoing specification, as indicating the scope of the invention.

TABLE I

| | Sample 1 | Sample 2 | Sample 3 | Sample 4 | Sample 5 |
|---|---|---|---|---|---|
| Polymer | DOWLEX ™ 2045 | DOWLEX ™ 2045 | DOWLEX ™ 2045 | DOWLEX ™ 2045 | DOWLEX ™ 2045 |
| Irganox ™ 1010 (ppm) | 200 | 200 | 200 | 200 | 200 |
| Irganox ™ 176 (ppm) | 250 | 250 | 250 | 250 | 250 |
| Irgafos ™ 168 (ppm) | 1000 | 1000 | 1000 | 1000 | 1000 |
| Copper (ppm) | 0 | 1 | 5 | 10 | 30 |

I claim:

1. A polymeric composition comprising:
a polyolefin, wherein said polyolefin being the polymerization reaction product of at least one or more α-olefins in a presence of a solvent via a solution polymerization reaction; and
a phenolic antioxidant;
wherein said polymeric composition containing less than 0.02 parts of copper per one million parts of said composition, and said polymeric composition having a whiteness index according to ASTM-D 6290 of equal or greater than [(−0.73 X)+(Wᵢ)] where X is the number of days of accelerated aging, and Wᵢ is the initial whiteness index at 0 days of accelerated aging.

2. The polymeric composition according to claim 1, wherein said polymeric composition is free of copper.

3. The polymeric composition according to claim 1, wherein said phenolic antioxidant being selected from the group consisting of octadecyl 3-(3,5-di-tert-butyl-4-hydroxyphenyl)propionate; and 3,5-di-tert-butyl-4-hydroxy hydrocinnamate.

4. The polymeric composition according to claim 1, wherein said polymeric composition further comprises a phosphite-based antioxidant.

5. The polymeric composition according to claim 4, wherein said phosphite-base antioxidant is Tris(2,4-di-tert-butylphenyl)phosphite.

6. The polymeric composition according to claim 1, wherein said polymerization reaction takes place in a copper free polymerization system.

7. The polymeric composition according to claim 1, wherein Wᵢ is equal or greater than 40.

8. A process for producing a polymeric composition comprising the steps of:
selecting a copper free polymerization system;
polymerizing at least one or more α-olefins in a presence of a solvent via a solution polymerization reaction in said copper free polymerization system;
thereby producing a polyolefin polymer;
melt blending a phenolic antioxidant into said polyolefin polymer; and
thereby producing said polymeric composition, wherein said polymeric composition containing less than 0.02 parts of copper per one million parts of said composition, and said polymeric composition having a whiteness index according to ASTM-D 6290 of equal or greater than [(−0.73 X)+(Wᵢ)] where X is the number of days of accelerated aging, and Wᵢ is the initial whiteness index at 0 days of accelerated aging.

9. The process for producing a polymeric composition according to claim 8, wherein said polymeric composition is free of copper.

10. The process for producing a polymeric composition according to claim 8, wherein said phenolic antioxidant being selected from the group consisting of octadecyl 3-(3,5-di-tert-butyl-4-hydroxyphenyl)propionate; and 3,5-di-tert-butyl-4-hydroxy hydrocinnamate.

11. The process for producing a polymeric composition according to claim 8, wherein said polymeric composition further comprises a phosphite-based antioxidant.

12. The process for producing a polymeric composition according to claim 11, wherein said phosphite-base antioxidant is Tris(2,4-di-tert-butylphenyl)phosphite.

13. A method of improving yellowness index of a polymeric composition comprising the steps of:
selecting a copper free polymerization system;
polymerizing at least one or more α-olefins in a presence of a solvent via a solution polymerization reaction in said copper free polymerization system;
thereby producing a polyolefin polymer;
melt blending a phenolic antioxidant into said polyolefin polymer; and
thereby producing said polymeric composition, wherein said polymeric composition containing less than 0.02 parts of copper per one million parts of said composition, and said polymeric composition having a whiteness index according to ASTM-D 6290 of equal or greater than [(−0.73 X)+(Wᵢ)] where X is the number of days of accelerated aging, and Wᵢ is the initial whiteness index at 0 days of accelerated aging.

14. An article comprising:
a polymeric composition comprising;
a polyolefin, wherein said polyolefin being the polymerization reaction product of at least one or more α-olefins in a presence of a solvent via a solution polymerization reaction; and
a phenolic antioxidant;
wherein said polymeric composition containing less than 0.02 parts of copper per one million parts of said composition, and said polymeric composition having a whiteness index according to ASTM-D 6290 of equal or greater than [(−0.73 X)+(Wᵢ)] where X is the number of days of accelerated aging, and Wᵢ is the initial whiteness index at 0 days of accelerated aging.
